(19) United States
(12) Patent Application Publication
(10) Pub. No.: US 2026/0179854 A1
(43) Pub. Date: Jun. 25, 2026

(54) METHOD FOR MANUFACTURING ELECTROLYTIC CAPACITOR, ELECTROLYTIC CAPACITOR, FIRST PROCESSING SOLUTION, AND SECOND PROCESSING SOLUTION

(71) Applicant: Panasonic Intellectual Property Management Co., Ltd., Osaka (JP)

(72) Inventors: YUKIYA SHIMOYAMA, Yamaguchi (JP); HONAMI KOJIMA, Osaka (JP); SHUMPEI MATSUSHITA, Yamaguchi (JP); YASUHIRO NISHIMURA, Hyogo (JP); TOSHIFUMI KADOKAWA, Hyogo (JP)

(21) Appl. No.: 19/129,036

(22) PCT Filed: Nov. 15, 2023
(86) PCT No.: PCT/JP2023/041046

§ 371 Date: May 12, 2025

(30) Foreign Application Priority Data
Nov. 30, 2022 (JP) 2022-192046

(51) Int. Cl. H01G 9/028; H01G 9/00; H01G 9/15

(52) U.S. Cl. CPC H01G 9/028; H01G 9/0036; H01G 9/15

(57) ABSTRACT

A method for producing an electrolytic capacitor includes the steps of: preparing a first processing solution containing a first conductive polymer component; preparing a second processing solution containing a second conductive polymer component; adhering the first conductive polymer component to a separator by applying the first processing solution to the separator; adhering the second conductive polymer component to at least one of an anode foil or a cathode foil by applying the second processing solution to the at least one of the anode foil or the cathode foil; producing a capacitor element by sequentially stacking the anode foil, the separator, and the cathode foil; and impregnating the capacitor element with a liquid component. The first processing solution contains a first polyhydric alcohol at a content of less than 10 mass % or does not substantially contain the first polyhydric alcohol. The second processing solution contains a second polyhydric alcohol at a content of 10 mass % or more.

### TECHNICAL FIELD

The present disclosure relates to a method for manufacturing an electrolytic capacitor, an electrolytic capacitor, a first processing solution, and a second processing solution.

### BACKGROUND

Capacitors used in electronic devices are required to have a large capacitance and a small equivalent series resistance (ESR) in a high frequency region. Promising candidates as large capacitance and low ESR capacitors are electrolytic capacitors using as a solid electrolyte a conductive polymer such as polypyrrole, polythiophene, polyfuran, or polyaniline.

PTL 1 discloses “A method for manufacturing an electrolytic capacitor, the method comprising the steps of: preparing electrode foil; preparing a first conductive polymer dispersion solution containing a first conductive polymer component and a first dispersion medium; applying the first conductive polymer dispersion solution to a surface of the electrode foil by a coating method, and then removing at least a part of the first dispersion medium to form a first conductive polymer layer containing the first conductive polymer component; and producing a capacitor element using the electrode foil on which the first conductive polymer layer is formed”.

PTL 2 discloses “A method for manufacturing an electrolytic capacitor, the method comprising the steps of: preparing anode foil provided with a dielectric layer, cathode foil, and a fiber structure; preparing a conductive polymer dispersion solution containing a conductive polymer component and a dispersion medium; applying the conductive polymer dispersion solution to the fiber structure, and then removing at least a part of the dispersion medium to produce a separator; and sequentially stacking the anode foil, the separator, and the cathode foil to produce a capacitor element, wherein the dispersion medium contains water, the fiber structure contains 50 mass % or more of synthetic fibers, and a density of the fiber structure is 0.2 g/cm³ or more and less than 0.45 g/cm³”.

### CITATION LIST

### Patent Literature

PTL 1: International Publication No. WO 2020/158780
PTL 2: International Publication No. WO 2020/158783

### SUMMARY

An aspect of the present disclosure relates to a method for manufacturing an electrolytic capacitor. The method includes the steps of: preparing an anode foil, a cathode foil, and a separator, the anode foil including a dielectric layer; preparing a first processing solution containing a first conductive polymer component; preparing a second processing solution containing a second conductive polymer component; adhering the first conductive polymer component to the separator by applying the first processing solution to the separator; adhering the second conductive polymer component to at least one of the anode foil or the cathode foil by applying the second processing solution to the at least one of the anode foil or the cathode foil; producing a capacitor element by sequentially stacking the anode foil, the separator to which the first conductive polymer component adheres, and the cathode foil after the step of adhering the second conductive polymer component; and impregnating the capacitor element with a liquid component. The first processing solution contains a first polyhydric alcohol or does not substantially contain the first polyhydric alcohol, and a content of the first polyhydric alcohol in the first processing solution is 0 mass % or more and less than 10 mass %. The second processing solution contains a second polyhydric alcohol, and a content of the second polyhydric alcohol in the second processing solution is 10 mass % or more.

Another aspect of the present disclosure relates to an electrolytic capacitor. The electrolytic capacitor includes a capacitor element and a liquid component. The capacitor element includes an anode foil including a dielectric layer, a cathode foil, a separator disposed between the anode foil and the cathode foil, a first conductive polymer component adhering to the separator, and a second conductive polymer component adhering to at least one of the anode foil or the cathode foil. The first conductive polymer component has a higher solubility in water than a solubility of the second conductive polymer component in water.

Still another aspect of the present disclosure relates to a first processing solution applied to a separator constituting a capacitor element of an electrolytic capacitor including the capacitor element and a liquid component. The first processing solution contains a first conductive polymer component, and contains or does not substantially contain a first polyhydric alcohol, and the first processing solution has a content of 0 mass % or more and less than 10 mass % of the first polyhydric alcohol. The first conductive polymer component adhering to the separator by application of the first processing solution to the separator migrates to another adjacent conductive polymer component during impregnation of the liquid component into the capacitor element.

Still another aspect of the present disclosure relates to a second processing solution applied to at least one of an anode foil and a cathode foil constituting a capacitor element of an electrolytic capacitor including the capacitor element and a liquid component, the second processing solution being used together with the first processing solution. The second processing solution contains a second conductive polymer component and a second polyhydric alcohol, and a content of the second polyhydric alcohol in the second processing solution is a content of 10 mass % or more.

### Advantageous Effect of Invention

The present disclosure enables reducing ESR of an electrolytic capacitor.

### BRIEF DESCRIPTION OF THE DRAWINGS

FIG. 1 is a sectional view schematically illustrating an electrolytic capacitor according to an exemplary embodiment of the present disclosure.

FIG. 2 is a perspective view illustrating a wound body partially developed.

### DESCRIPTION OF EMBODIMENT

Prior to describing exemplary embodiments of the present disclosure, problems in the prior art will be briefly described. A capacitor element is produced by adhering a conductive polymer component by applying a dispersion solution of the conductive polymer component to a surface of each of anode foil, cathode foil, and a separator. And then the separator is disposed between the anode foil and the cathode foil. Unfortunately, an interface resistance between the separator and each of the anode foil and the cathode foil may increase to increase ESR.

Although the exemplary embodiments of the present disclosure will be described below with reference to examples, the present disclosure is not limited to the examples to be described below. Although the description below may show specific numerical values and materials as examples, other numerical values and materials may be used as long as effect of the present disclosure can be achieved. Description, “numerical value A to numerical value B”, herein includes numerical value A and numerical value B, and can be read as “between numerical value A and numerical value B inclusive”. When the description below shows lower limits and upper limits related to numerical values of specific physical properties, conditions, or the like, as examples, any of the lower limits shown and any of the upper limits shown can be optionally combined unless the lower limit is equal to or more than the upper limit. When a plurality of materials is shown as examples, one kind of material may be selected among the materials and used alone, or two or more kinds of material of the materials may be used in combination.

The present disclosure also includes a combination of matters recited in two or more claims optionally selected from a plurality of claims recited in the scope of claims appended. That is, the matters recited in two or more claims optionally selected from the plurality of claims recited in the scope of claims appended can be combined as long as no technical contradiction arises.

### [Method for Manufacturing Electrolytic Capacitor]

A method for manufacturing an electrolytic capacitor according to an exemplary embodiment of the present disclosure includes first to seventh steps.

The first step: preparing an anode foil including a dielectric layer, a cathode foil, and a separator.

The second step: a first processing solution containing a first conductive polymer component is prepared. The first processing solution contains a first polyhydric alcohol or does not substantially contain the first polyhydric alcohol, and a content of the first polyhydric alcohol in the first processing solution is 0 mass % or more and less than 10 mass %.

The third step: a second processing solution containing a second conductive polymer component is prepared. The second processing solution contains a second polyhydric alcohol, and a content of the second polyhydric alcohol in the second processing solution is 10 mass % or more.

The fourth step: the first conductive polymer component is adhered to the separator by applying the first processing solution to the separator. The fourth step is performed to form a first conductive polymer layer containing the first conductive polymer component on at least a surface of the separator.

The fifth step: the second conductive polymer component is adhered to at least one of the anode foil or the cathode foil by applying the second processing solution to the at least one of the anode foil or the cathode foil. The fifth step is performed to form a second conductive polymer layer containing the second conductive polymer component on the at least one of surfaces of the anode foil or the cathode foil.

The sixth step: a capacitor element is produced by sequentially stacking the anode foil, the separator to which the first conductive polymer component adheres, and the cathode foil.

The seventh step: the capacitor element is impregnated with a liquid component.

Hereinafter, the second processing solution applied to the anode foil may be referred to as a “2A-th processing solution”. The second processing solution applied to the cathode foil may be referred to as a “2B-th processing solution”. The 2A-th processing solution contains a 2A-th conductive polymer component as the second conductive polymer component and a 2A-th polyhydric alcohol as the second polyhydric alcohol. The 2B-th processing solution contains a 2B-th conductive polymer component as the second conductive polymer component and a 2B-th polyhydric alcohol as the second polyhydric alcohol. The 2A-th processing solution and the 2B-th processing solution may be identical or different in solution composition. The second processing solution may be applied only to the anode foil, only to the cathode foil, or to both the anode foil and the cathode foil. The anode foil, the cathode foil, and the separator are collectively referred to also as a “component”. The anode foil and the cathode foil are collectively referred to also as “electrode foil”.

The polyhydric alcohol contributes to improvement of crystallinity (orientation) of the conductive polymer component and improvement of conductivity thereby. The polyhydric alcohol also contributes to improvement in adhesion (impregnation property) of the conductive polymer component to the component.

When the second processing solution is caused to contain a large amount (10 mass % or more) of the second polyhydric alcohol, crystallinity of the second conductive polymer component is improved, and thus conductivity of the second conductive polymer component is improved. Further, the second conductive polymer component has high adhesion to a surface of the electrode foil, so that a state in which the second conductive polymer component firmly adheres to the surface of the electrode foil is maintained even after impregnation with the liquid component. The electrode foil to which the second conductive polymer component adheres using the second processing solution is particularly advantageous in terms of low ESR and high capacitance in a low frequency region.

The first processing solution contains a small amount (less than 10 mass %) of the first polyhydric alcohol, or the first processing solution does not substantially contain the first polyhydric alcohol. Hence, the first conductive polymer component has relatively low adhesion to the surface of the separator. Thus, in the seventh step (the step of impregnating the capacitor element with the liquid component), the liquid component is impregnated between the electrode foil and the separator so that the first conductive polymer component (particularly, the first conductive polymer component adhering to an outer surface of the separator) migrates into the second conductive polymer component. Consequently, many conductive paths are formed between the first conductive polymer component adhering to the surface of the separator and the second conductive polymer component adhering to the surface of the electrode foil, so that interface resistance between the electrode foil and the separator is reduced.

As described above, by applying the first processing solution to the separator and applying the second processing solution to the electrode foil, an electrolytic capacitor with low ESR can be obtained.

### (First Step)

An anode foil including a dielectric layer, a cathode foil, and a separator are prepared. Hereinafter, these components will be described.

### (Anode Foil Including Dielectric Layer)

Examples of the anode foil include a metal foil containing at least one of valve metals such as titanium, tantalum, aluminum, and niobium, and metal foil made of a valve metal (e.g., aluminum foil). The anode foil may contain the valve metal in a form such as an alloy containing the valve metal or a compound containing the valve metal. A thickness of the anode foil may range from 15 μm to 300 μm, inclusive. A surface of the anode foil may be roughened by etching or the like. The anode foil with the surface roughened includes a core part and a porous part continuous with the core part.

On the surface of the anode foil, a dielectric layer is formed. The dielectric layer is formed by subjecting the anode foil to an anodizing treatment, for example. This treatment enables the dielectric layer to contain an oxide of a valve metal (e.g., aluminum oxide). When the anode foil with the surface provided with the porous part is subjected to the anodizing treatment, the dielectric layer is formed covering a metal skeleton constituting the porous part. The dielectric layer only needs to function as a dielectric material, and thus may be made of a dielectric material other than an oxide of a valve metal.

The electrolytic capacitor may include the anode foil with an end surface without being covered by a conductive polymer layer. Meanwhile, the end surface of the anode foil is desirably covered by a dielectric layer.

### (Cathode Foil)

The cathode foil is not particularly limited as long as it has a function as a cathode. Examples of the cathode foil include a metal foil (e.g., aluminum foil). The metal is not particularly limited in kind, and may be a valve metal or an alloy containing a valve metal. A thickness of the cathode foil may range from 15 μm to 300 μm, inclusive. A surface of the cathode foil may be roughened or subjected to an anodizing treatment as necessary.

The cathode foil may include a conductive covering layer. When the metal foil includes a valve metal, the covering layer may include carbon and at least one kind of metal having a lower ionization tendency than the valve metal. This configuration facilitates improvement in acid resistance of the metal foil. When the metal foil contains aluminum, the covering layer may contain at least one kind selected from the group consisting of carbon, nickel, titanium, tantalum, and zirconium. Among others, the covering layer may contain nickel and/or titanium in terms of low cost and resistance.

A thickness of the covering layer may be 5 nm or more, or 10 nm or more, and may be 200 nm or less. The covering layer may be formed by depositing or sputtering the metal on the metal foil. Alternatively, the covering layer may be formed by depositing a conductive carbon material on the metal foil or applying a carbon paste containing a conductive carbon material on the metal foil. Examples of the conductive carbon material include graphite, hard carbon, soft carbon, and carbon black.

### (Separator)

A porous sheet can be used as the separator. Examples of the porous sheet include a woven fabric, a nonwoven fabric, and a microporous membrane. A thickness of the separator is not particularly limited, and may be in a range from 10 μm to 300 μm, inclusive. Examples of a material for the separator include cellulose, polyethylene terephthalate, polybutylene terephthalate, polyphenylenesulfide, vinylon, nylon, aromatic polyamide, polyimide, polyamideimide, polyetherimide, rayon, and glass.

### (Second Step)

### (First Processing Solution)

In the second step, the first processing solution containing the first conductive polymer component is prepared. The first processing solution is applied to the separator constituting the capacitor element of the electrolytic capacitor including the capacitor element and the liquid component.

The first processing solution contains a first polyhydric alcohol or does not substantially contain the first polyhydric alcohol. The text, “does not substantially contain”, means a content below a detection limit of an analyzer (such as a liquid chromatography analyzer). From the viewpoint of reducing the ESR, a content of the first polyhydric alcohol in the first processing solution ranges from 0 mass % to 10 mass %, inclusive, and preferably from 0 mass % to 5 mass %, inclusive.

The first conductive polymer component is dispersed (or dissolved) in the first processing solution. The first processing solution may contain water, or water and the first polyhydric alcohol, as a dispersion medium (or solvent). The first polyhydric alcohol may be a compound used as an organic solvent, or may be a mixed dispersion medium (mixed solvent) of water and the first polyhydric alcohol. Water in which the first polyhydric alcohol is dissolved may be used as a dispersion medium (or solvent). As the dispersion medium (or solvent), another component other than water and the first polyhydric alcohol may be contained. As the other component, a nonaqueous solvent exemplified by the liquid component may be contained.

In the first processing solution, a mass of the first polyhydric alcohol is preferably less than 5 times a mass of the first conductive polymer component, and more preferably 2.5 times or less the mass of the first conductive polymer component.

### (Third Step)

### (Second Processing Solution)

In the third step, the second processing solution containing the second conductive polymer component is prepared. The second processing solution is used together with the first processing solution, and applied to the electrode foil constituting the capacitor element of the electrolytic capacitor including the capacitor element and the liquid component. Specifically, the 2A-th processing solution is applied to the anode foil, and the 2B-th processing solution is applied to the cathode foil.

The second processing solution contains the second conductive polymer and the second polyhydric alcohol. From the viewpoint of reducing the ESR, a content of the second polyhydric alcohol in the second processing solution is 10 mass % or more, and preferably ranges from 10 mass % (or 15 mass %) to 30 mass %, inclusive.

The second conductive polymer component is dispersed (or dissolved) in the second processing solution. The second processing solution may contain water and the second polyhydric alcohol as a dispersion medium (or solvent). The second polyhydric alcohol may be a compound used as an organic solvent, or may be a mixed dispersion medium (mixed solvent) of water and the second polyhydric alcohol. Water in which the second polyhydric alcohol is dissolved may be used as a dispersion medium (or solvent). As the dispersion medium (or solvent), another component other than water and the second polyhydric alcohol may be contained. As the other component, a nonaqueous solvent exemplified by the liquid component may be contained.

In the second processing solution, a mass of the second polyhydric alcohol is preferably from 5 times to 30 times, inclusive, a mass of the second conductive polymer component, more preferably from 5 times to 25 times, inclusive, the mass of the second conductive polymer component, and still more preferably from 7 times to 15 times, inclusive, the mass of the second conductive polymer component.

Hereinafter, the polyhydric alcohol and the conductive polymer component used in the processing solution (the first processing solution and the second processing solution) will be described.

### (Polyhydric Alcohol)

The polyhydric alcohol preferably contains at least one kind selected from the group consisting of a glycol compound, a glycerin compound, and a sugar alcohol compound. This polyhydric alcohol facilitates swelling of the conductive polymer component. The second polyhydric alcohol may contain a compound identical to that of the first polyhydric alcohol, or a compound different from that of the first polyhydric alcohol.

Examples of the glycol compound include ethylene glycol, propylene glycol, diethylene glycol, triethylene glycol, polyalkylene glycol (e.g., polyethylene glycol), and polyoxyethylene polyoxypropylene glycol (ethylene oxide-propylene oxide copolymer). Examples of the glycerin compound include glycerin and polyglycerin. Examples of the sugar alcohol compound include mannitol, xylitol, sorbitol, erythritol, and pentaerythritol. Among them, ethylene glycol is preferable from the viewpoint of affinity with the processing solution and film formability of the conductive polymer component.

A boiling point of the polyhydric alcohol may be higher than 100° C., is 110° C. or higher, 150° C. or higher, or 200° C. or higher, and is 400° C. or lower, 300° C. or lower, 250° C. or lower, or 200° C. or lower. The boiling point may be in a range from 110° C. to 400° C., inclusive (e.g., in a range of 150° C. to 350° C., inclusive).

### (Conductive Polymer Component)

The conductive polymer component may contain a conductive polymer and include only the conductive polymer. Alternatively, the conductive polymer component may include a conductive polymer and a dopant. The second conductive polymer component may contain a compound identical to that of the first conductive polymer component or a compound different from that of the first conductive polymer component.

Examples of the conductive polymer include polypyrrole, polythiophene, polyaniline, and derivatives thereof. The derivatives include polymers having polypyrrole, polythiophene, polyfuran, polyaniline, and polyacetylene as a basic skeleton. For example, the derivative of polythiophene includes poly(3,4-ethylenedioxythiophene) and the like. These conductive polymers may be used singly or in combination of two or more kinds thereof. The conductive polymers may be each a copolymer of two or more kinds of monomers. A weight-average molecular weight of the conductive polymer is not particularly limited and may be in a range from 1000 to 100000, inclusive, for example. A preferred example of the conductive polymer is poly(3,4-ethylenedioxythiophene) (PEDOT).

The conductive polymer may be doped with a dopant. From the viewpoint of suppressing dedoping from the conductive polymer, a polymer dopant is preferably used as the dopant. Examples of the polymer dopant include polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These may be used singly or in combination of two or more kinds thereof. At least some of these may be added in the form of a salt. A preferred example of the dopant is polystyrenesulfonic acid (PSS).

The dopant may contain an acidic group, or may be a polymer dopant containing an acidic group. Examples of the acidic group include a sulfonic acid group and a carboxyl group. The polymer dopant containing an acidic group is a polymer in which at least a part of constituent units contains an acidic group. Examples of such a polymer dopant include the polymer dopants described above.

The dopant has a weight average molecular weight that is not particularly limited. From the viewpoint of facilitating formation of a homogeneous conductive polymer layer, a weight average molecular weight of the dopant may be in a range from 1000 to 100000, inclusive.

The dopant may be polystyrene sulfonic acid, and the conductive polymer may be poly (3,4-ethylenedioxythiophene). That is, the conductive polymer component may be poly (3,4-ethylenedioxythiophene) doped with polystyrenesulfonic acid.

When a conductive polymer doped with a dopant is used, a pH of a processing solution preferably is less than 7.0, and may be 6.0 or less, or 5.0 or less to suppress dedoping of the dopant. A pH of the processing solution may be 1.0 or more, or 2.0 or more.

The conductive polymer component may be present in the processing solution in the form of particles. In a particle size distribution on a volume basis of the particles for the conductive polymer component, a mode value of the particle sizes may be 10 nm or more, or 20 nm or more, and may be 1000 nm or less, 500 nm or less, 200 nm or less, or 100 nm or less. The particle size distribution on a volume basis can be acquired using a particle size distribution measurement device of a laser diffraction and scattering type.

The mode value of the particle sizes for the conductive polymer component may be in a range from 20 nm to 200 nm, inclusive (e.g., in a range from 20 nm to 100 nm, inclusive). In the particle size distribution on a volume basis, a proportion of particles each having a particle size in the range from 20 nm to 100 nm, inclusive, may be 90% or more to the whole of particles at a volume basis. Within these ranges, formation of the conductive polymer layer containing the conductive polymer component in pores of members (electrode foil and separator) is facilitated.

A content of the conductive polymer component in the processing solution may be 0.5 mass % or more, or 1.0 mass % or more, and 4.0 mass % or less, 3.0 mass % or less, or 2.0 mass % or less. The content may be in a range from 0.5 mass % to 4.0 mass %, inclusive, or from 1.0 mass % to 4.0 mass %, inclusive. Any of these ranges may have an upper limit of 3.0 mass % or 2.0 mass %. The content is preferably in a range from 1.0% to 3.0%, inclusive, from the viewpoint of excellent physical properties of the processing solution and temporal stability thereof, and good balance between ESR and cost of the electrolytic capacitor. When the processing solution contains the dopant, mass of the dopant is included in mass of the conductive polymer component.

### (Fourth Step and Fifth Step)

The processing solution is applied to each component for adhesion of the conductive polymer component. Consequently, a conductive polymer layer containing the conductive polymer component is formed on a surface of the component. After the application, a coating film may be subjected to drying treatment to remove at least a part of the dispersion medium (solvent). The drying treatment may be performed by heat treatment or under reduced pressure.

The fourth step is performed to adhere the first conductive polymer component to the separator by applying the first processing solution to the separator. Consequently, the first conductive polymer layer containing the first conductive polymer component is formed on the surface of the separator. The fifth step is performed to adhere the second conductive polymer component to the electrode foil by applying the second processing solution to the electrode foil. Specifically, the 2A-th processing solution is applied to the anode foil (dielectric layer) so that the 2A-th conductive polymer component is adhered to the anode foil. Consequently, a 2A-th conductive polymer layer containing the 2A-th conductive polymer component is formed on the surface of the anode foil (on the dielectric layer). The 2B-th processing solution is applied to the cathode foil so that the 2B-th conductive polymer component is adhered to the cathode foil. Consequently, a 2B-th conductive polymer layer containing the 2B-th conductive polymer component is formed on a surface of the cathode foil.

A method for applying the processing solution is not limited, and the processing solution may be applied by a publicly known method. Examples of the method include a method using a coater, a method for spraying the processing solution, and a method for immersing an object to be applied in the processing solution. Examples of the method using a coater include a gravure coating method and a die coating method. A method for applying the first processing solution to the separator includes a method for impregnating the separator with the first processing solution. The first processing solution applied to the separator penetrates into the separator, and the first conductive polymer layer can be formed throughout the separator in its thickness direction.

The fourth step and/or the fifth step may include step (a) of removing a part of the dispersion medium (or solvent) to cause the polyhydric alcohol to remain in the conductive polymer layer after the application of the processing solution. By this step, the conductive polymer layer that has been formed can be prevented from being excessively shrunk, so that impregnating ability of the liquid component can be enhanced.

The method for removing the dispersion medium (or solvent) from the processing solution is not particularly limited as long as a part of the dispersion medium (or solvent) can be removed to cause the polyhydric alcohol to remain in the conductive polymer layer. The dispersion medium (or solvent) may be removed by heating and/or under reduced pressure, and performing at least heating is preferable.

When heating is performed, it is preferable to remove a part of the dispersion medium (or solvent) by performing heating at a temperature of 100° C. or higher. By heating at a temperature of 100° C. or higher, water in the processing solution can be quickly removed. Heating temperature is preferably a temperature at which the polyhydric alcohol does not boil or decompose. When the polyhydric alcohol is a compound having no clear boiling point, the heating is preferably performed at a temperature at which the polyhydric alcohol evaporates a little and the polyhydric alcohol is not decomposed. The heating temperature may be 100° C. or higher, 120° C. or higher, or 140° C. or higher, and may be 200° C. or lower, or 160° C. or lower. The heating temperature may be in a range from 100° C. to 200° C., inclusive. Heating time is not particularly limited as long as a part of the dispersion medium (or solvent) can be appropriately removed in time. The heating time is in a range from 5 minutes to 60 minutes, inclusive, for example.

When the 2A-th conductive polymer layer is formed on the dielectric layers formed on both the surfaces of the anode foil, the heating may be performed after the processing solution is applied to one of the surfaces, and the heating may be performed after the processing solution is applied to the other of the surfaces. A similar method can also be applied when the 2B-th conductive polymer layer is formed on both surfaces of the cathode foil.

For example, step (a) may be performed to cause a mass of the polyhydric alcohol in the conductive polymer layer to be greater than a mass of water in the conductive polymer layer. In this step, the conductive polymer component is likely to swell in the processing solution having a high water content, and the conductive polymer layer is likely to be formed while a swollen state is maintained to some extent. In the seventh step, the second conductive polymer layer is likely to be impregnated with the liquid component.

### (Sixth Step)

The anode foil to which the second conductive polymer component adheres, the separator to which the first conductive polymer component adheres, and the cathode foil to which the second conductive polymer component adheres are sequentially stacked to produce a capacitor element. The capacitor element includes a solid electrolyte containing the first conductive polymer component and the second conductive polymer component. The separator to which the first conductive polymer component adheres is also referred to below as “separator S”. The anode foil to which the second conductive polymer component adheres is also referred to below as “anode foil P”. The cathode foil to which the second conductive polymer component adheres is also referred to below as “cathode foil N”.

In the sixth step, anode foil P and cathode foil N may be wound with separator S interposed between anode foil P and cathode foil N to obtain a wound body. In the sixth step, anode foil P and cathode foil N may be stacked with separator S interposed between anode foil P and cathode foil N to obtain a stacked body.

### (Seventh Step)

The capacitor element is impregnated with the liquid component. An impregnation step (seventh step) of the liquid component includes a step of migrating the first conductive polymer component into the second conductive polymer component to increase a conductive path between the second conductive polymer component and the first conductive polymer component.

The conductive polymer component is protected by the liquid component, so that oxidation degradation of the conductive polymer component is prevented. A decrease in conductivity due to the oxidation degradation of the conductive polymer component is prevented, and an increase in ESR due to the decrease in conductivity is prevented. The liquid component also repairs a defect part of the dielectric layer, and thus an increase in leak current due to the defect of the dielectric layer is prevented.

### (Liquid Component)

The liquid component impregnated into the capacitor element may be a non-aqueous solvent or an electrolytic solution. The electrolytic solution contains a non-aqueous solvent and a solute (e.g., a salt described later) dissolved in the non-aqueous solvent. The liquid component herein may be a component that is in a liquid state at room temperature (25° C.), or may be a component that is in a liquid state at a temperature when the electrolytic capacitor is used.

The non-aqueous solvent used for the liquid component may be an organic solvent, an ionic liquid, or a protic solvent. Examples of the non-aqueous solvent include polyhydric alcohols such as ethylene glycol and propylene glycol, cyclic sulfones such as sulfolane, lactones such as γ-butyrolactone, amides such as N-methylacetamide, N,N-dimethylformamide, and N-methyl-2 pyrrolidone, esters such as methyl acetate, carbonate compounds such as propylene carbonate, ethers such as 1,4-dioxane, ketones such as methyl ethyl ketone, and formaldehyde.

As the non-aqueous solvent, a polymer solvent may be used. Examples of the polymer solvent include polyalkylene glycol, a derivative of polyalkylene glycol, and a compound obtained by substituting at least one hydroxyl group in a polyhydric alcohol with polyalkylene glycol (including a derivative). The examples of the polymer solvent specifically include polyethylene glycol (PEG), polyethylene glycol glyceryl ether, polyethylene glycol diglyceryl ether, polyethylene glycol sorbitol ether, polypropylene glycol, polypropylene glycol glyceryl ether, polypropylene glycol diglyceryl ether, polypropylene glycol sorbitol ether, and polybutylene glycol. The examples of the polymer solvent further include an ethylene glycol-propylene glycol copolymer, an ethylene glycol-butylene glycol copolymer, and a propylene glycol-butylene glycol copolymer. As the nonaqueous solvent, one kind of the examples may be used alone, or two or more kinds thereof may be used in combination.

From the viewpoint of suppressing dedoping of the dopant, the liquid component may contain an acid component. As the acid component, a polycarboxylic acid and a monocarboxylic acid may be used.

Examples of the polycarboxylic acid include aliphatic polycarboxylic acids ([saturated polycarboxylic acids such as oxalic acid, malonic acid, succinic acid, glutaric acid, adipic acid, pimelic acid, suberic acid, azelaic acid, sebacic acid, 1,6-decanedicarboxylic acid, and 5,6-decanedicarboxylic acid]; and [unsaturated polycarboxylic acids such as maleic acid, fumaric acid, and itaconic acid]), aromatic polycarboxylic acids (such as phthalic acid, isophthalic acid, terephthalic acid, trimellitic acid, and pyromellitic acid), and alicyclic polycarboxylic acids (such as cyclohexane-1,2-dicarboxylic acid and cyclohexene-1,2-dicarboxylic acid).

Examples of the monocarboxylic acid include aliphatic monocarboxylic acids (1 to 30 carbon atoms) ([saturated monocarboxylic acids such as formic acid, acetic acid, propionic acid, butyric acid, isobutyric acid, valeric acid, caproic acid, enanthic acid, caprylic acid, pelargonic acid, lauric acid, myristic acid, stearic acid, and behenic acid]; and [unsaturated monocarboxylic acids such as acrylic acid, methacrylic acid, and oleic acid]), aromatic monocarboxylic acids (such as benzoic acid, cinnamic acid, and naphthoic acid), and oxycarboxylic acids (such as salicylic acid, mandelic acid, and resorcinol acid).

Among these, maleic acid, phthalic acid, benzoic acid, pyromellitic acid, and resorcinol acid are thermally stable, and are preferably used.

As the acid component, an inorganic acid may be used. Typical examples of the inorganic acid include phosphoric acid, phosphorous acid, hypophosphorous acid, alkyl phosphoric acid ester, boric acid, fluoroboric acid, tetrafluoroboric acid, hexafluorophosphoric acid, benzenesulfonic acid, and naphthalenesulfonic acid. As the acid component, a composite compound of an organic acid and an inorganic acid may be used. Examples of such a composite compound include borodiglycolic acid, borodioxalic acid, and borodisalicylic acid.

The liquid component may contain a base component together with an acid component. The base component may be a compound having an alkyl-substituted amidine group, and examples of the compound include an imidazole compound, a benzimidazole compound, and an alicyclic amidine compound (a pyrimidine compound and an imidazoline compound). Preferable examples specifically include 1,8-diazabicyclo[5,4,0]undecene-7,1,5-diazabicyclo[4,3,0]nonene-5, 1,2-dimethylimidazolinium, 1,2,4-trimethylimidazoline, 1-methyl-2-ethyl-imidazoline, 1,4-dimethyl-2-ethylimidazoline, 1-methyl-2-heptylimidazoline, 1-methyl-2-(3′ heptyl) imidazoline, 1-methyl-2-dodecylimidazoline, 1,2-dimethyl-1,4,5,6-tetrahydropyrimidine, 1-methylimidazole, and 1-methylbenzimidazole. Using any of the examples enables obtaining a capacitor excellent in impedance performance.

As the base component, a quaternary salt of a compound having an alkyl-substituted amidine group may be used. Examples of such a base component include an imidazole compound, a benzimidazole compound, and an alicyclic amidine compound (a pyrimidine compound or an imidazoline compound) that are quaternized by an alkyl group or an arylalkyl group having 1 to 11 carbon atoms. Preferable examples specifically include 1-methyl-1,8-diazabicyclo[5,4,0]undecene-7, 1-methyl-1,5-diazabicyclo[4,3,0]nonene-5, 1,2,3-trimethylimidazolinium, 1,2,3,4-tetramethylimidazolinium, 1,2-dimethyl-3-ethyl-imidazolinium, 1,3,4-trimethyl-2-ethylimidazolinium, 1,3-dimethyl-2-heptylimidazolinium, 1,3-dimethyl-2-(3′heptyl) imidazolinium, 1,3-dimethyl-2-dodecylimidazolinium, 1,2,3-trimethyl-1,4,5,6-tetrahydropyrimidium, 1,3-dimethylimidazolium, 1-methyl-3-ethylimidazolium, and 1,3-dimethylbenzimidazolium. Using any of the examples enables obtaining a capacitor excellent in impedance performance.

As the base component, a tertiary amine may be used. Examples of the tertiary amine include trialkylamines (such as trimethylamine, dimethylethylamine, methyldiethylamine, triethylamine, dimethyl-n-propylamine, dimethylisopropylamine, methylethyl-n-propylamine, methylethylisopropylamine, diethyl-n-propylamine, diethylisopropylamine, tri-n-propylamine, triisopropylamine, tri-n-butylamine, and tri-tert-butylamine) and phenyl group-containing amines (such as dimethylphenylamine, methylethylphenylamine, and diethylphenylamine). Among them, the trialkylamine is preferable in terms of high conductivity, and containing at least one kind selected from the group consisting of trimethylamine, dimethylethylamine, methyldiethylamine, and triethylamine is more preferable. As the base component, a secondary amine such as a dialkylamine, a primary amine such as a monoalkylamine, or ammonia may be used.

The liquid component may contain a salt of the acid component with the base component. The salt may be an inorganic salt and/or an organic salt. The organic salt contains an anion and a cation at least one of which contains an organic substance. The organic salt is preferably an amine salt of an organic acid, for example. Examples of the organic salt include trimethylamine maleate, triethylamine borodisalicylate, triethylamine phthalate, ethyldimethylamine phthalate, mono 1,2,3,4-tetramethylimidazolinium phthalate, and mono 1,3-dimethyl-2 ethylimidazolinium phthalate.

In order to suppress dedoping of the dopant, a pH of the liquid component may be less than 7.0, or 5.0 or less, or 1.0 or more, or 2.0 or more. The pH may be 1.0 or more and less than 7.0 (e.g., in a range from 2.0 to 5.0, inclusive).

The liquid component preferably contains a protic solvent. Using the protic solvent enables the conductive polymer layer to be particularly swollen.

The liquid component may contain a third polyhydric alcohol as the protic solvent. The third polyhydric alcohol preferably contains at least one kind selected from the group consisting of a glycol compound, a glycerin compound, and a sugar alcohol compound. The third polyhydric alcohol may contain a compound identical to that of at least one of the first polyhydric alcohol and the second polyhydric alcohol. The first polyhydric alcohol to the third polyhydric alcohol each may contain the same compound.

### (Others)

The method for manufacturing an electrolytic capacitor may include a step of sealing the capacitor element impregnated with the liquid component. For example, the step may include: housing the capacitor element and the liquid component in a bottomed case; disposing a sealing member at an opening of the bottomed case; subjecting a part near an opening end of the bottomed case to transverse drawing; crimping the opening end to the sealing member to form a curled part; and disposing a base plate at the curled part. In this way, the electrolytic capacitor may be obtained. After that, the electrolytic capacitor may be subjected to aging treatment while rated voltage is applied.

### [Electrolytic Capacitor]

An electrolytic capacitor according to an exemplary embodiment of the present disclosure includes a capacitor element and a liquid component. The capacitor element includes an anode foil provided with a dielectric layer, a cathode foil, a separator disposed between the anode foil and the cathode foil, a first conductive polymer component adhering to the separator, and a second conductive polymer component adhering to the anode foil and the cathode foil. The first conductive polymer component has higher solubility in water than the second conductive polymer component. That is, adhesion of the first conductive polymer component to a surface of the separator is lower than adhesion of the second conductive polymer component to a surface of the electrode foil. The electrolytic capacitor is obtained by the method for manufacturing an electrolytic capacitor according to an exemplary embodiment of the present disclosure.

In a condition that an immersion of the separator to which the first conductive polymer component adheres in water at 25° C. for 10 minutes is conducted, the separator being preliminarily dried at 105° C. for 30 minutes, and then the separator is dried again at 105° C. for 30 minutes, a mass change ratio R of the separator before and after the immersion is preferably 20 mass % or more, and may be 30 mass % or more, or may range from 30 mass % to 60 mass %, inclusive. In this case, adhesion of the first conductive polymer component to the surface of the separator is low to an extent that the first conductive polymer component is allowed to migrate to the second conductive polymer component and to fill a gap between the electrode foil and the separator after impregnation with the liquid component.

In a condition that an immersion of at least one of the anode foil or the cathode foil to which the second conductive polymer component adheres in water at 25° C. for 10 minutes, the at least one of the anode foil or the cathode foil being preliminarily dried at 105° C. for 30 minutes, and then the at least one of the anode foil or the cathode foil is dried again at 105° C. for 30 minutes, a mass change ratio R of the at least one of the anode foil or the cathode foil before and after the immersion is preferably less than 2 mass %, and is more preferably 1 mass % or less. In this case, adhesion of the second conductive polymer component to the surface of the electrode foil is high to an extent that a state where the second conductive polymer component firmly adheres to the surface of the electrode foil is maintained even after impregnation with the liquid component.

The mass change ratio R of the component (separator, anode foil, cathode foil) to which the conductive polymer component adheres before and after immersion is determined as follows.

The component is preliminary dried at 105° C. for 30 minutes, and then mass M1 is measured. Next, the component is immersed in water at 25° C. for 10 minutes, and then dried at 105° C. for 30 minutes. Mass M2 of the component after drying is measured. Mass change ratio R is acquired by Expression (1) below using M1 and M2 obtained.

$$Mass change ratio R = \{ ( M 1 - M 2 ) / M 1 \} \times 100 \qquad ( 1 )$$

By applying the first processing solution to the surface of the separator, the first conductive polymer layer containing the first conductive polymer component is formed on the surface of the separator. An electrical conductivity of the first conductive polymer layer (first conductive polymer component) may be 0.1 S/cm or less, for example, or 0.05 S/cm or less.

By applying the second processing solution to the surface of the electrode foil, the second conductive polymer layer containing the second conductive polymer component is formed on the surface of the electrode foil. An electrical conductivity of the second conductive polymer layer (second conductive polymer component) may be 0.5 S/cm or more, 3 S/cm or more, or 10 S/cm or more.

The electrical conductivity of the first conductive polymer layer is measured on a surface of a sample obtained by applying a processing solution used for formation of the first conductive polymer layer to the separator, and sufficiently drying a coating film to remove the dispersion medium (or solvent). The electrical conductivity of the second conductive polymer layer is measured on a surface of a sample obtained by applying a processing solution used for formation of the second conductive polymer layer to the electrode foil, and sufficiently drying a coating film to remove the dispersion medium (or solvent). The electrical conductivity is determined in conformity with “Method for Testing Resistivity of Conductive Plastic by 4-Probe Method” of Japanese Industrial Standards (JIS K 7194). Available measurement devices include a low resistivity meter with a PSP probe or an ESP probe.

A mass of the liquid component is preferably 20 times or more a total mass of the first conductive polymer component and the second conductive polymer component (the 2A-th conductive polymer component and the 2B-th conductive polymer component). A mass of the liquid component is more preferably 80 times or more the total mass of the first conductive polymer component and the second conductive polymer component (the 2A-th conductive polymer component and the 2B-th conductive polymer component). In this case, the liquid component can be sufficiently impregnated between the separator to which the first conductive polymer component adheres on its surface and the electrode foil to which the second conductive polymer component adheres on its surface. Hence, the first conductive polymer component can be migrated to the second conductive polymer component. Further, the conductive polymer component can be sufficiently protected by the liquid component.

The capacitor element may be a stacked body formed by stacking an anode foil to which the 2A-th conductive polymer component adheres, a separator to which the first conductive polymer component adheres, and a cathode foil to which the 2B-th conductive polymer component adheres, in this order. The capacitor element may be a wound body formed by winding an anode foil to which the 2A-th conductive polymer component adheres, and a cathode foil to which the 2B-th conductive polymer component adheres with a separator to which the first conductive polymer component adheres being interposed between the anode foil and the cathode foil. The electrolytic capacitor may include one capacitor element or a plurality of capacitor elements.

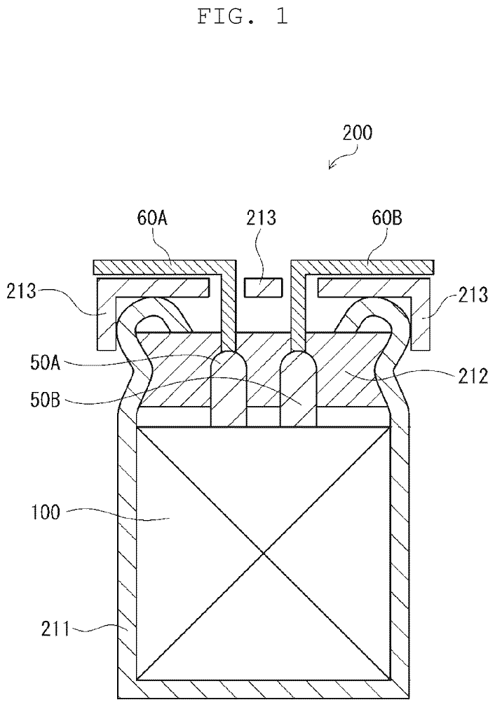

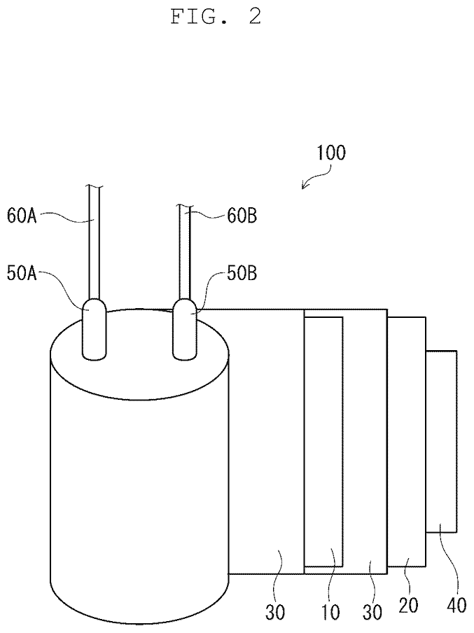

FIG. 1 is a sectional view schematically illustrating an electrolytic capacitor according to one exemplary embodiment of the present disclosure. FIG. 2 is a perspective view illustrating a wound body partially developed.

Electrolytic capacitor 200 includes wound body 100 as a capacitor element. Wound body 100 is formed by winding anode foil 10 to which the 2A-th conductive polymer component adheres and cathode foil 20 to which the 2B-th conductive polymer component adheres with separator 30 to which the first conductive polymer component adheres being interposed between anode foil 10 and cathode foil 20. Wound body 100 is impregnated with a liquid component (not illustrated).

Anode foil 10 and cathode foil 20 are connected to one ends of lead tabs 50A and 50B, respectively, and wound body 100 is formed while lead tabs 50A and SOB are wound. Lead tabs 50A and 50B are connected at the other ends to lead wires 60A and 60B, respectively.

Winding stop tape 40 is disposed on an outer surface of cathode foil 20 positioned at an outermost layer of wound body 100, and an end of cathode foil 20 is fixed by winding stop tape 40. When anode foil 10 is prepared by cutting large foil, an anodizing treatment may further be performed on wound body 100 to provide a dielectric layer on a cutting surface.

Electrolytic capacitor 200 includes sealing member 212 that closes an opening of bottomed case 211, and base plate 213 covering sealing member 212. Wound body 100 is housed in bottomed case 211 with lead wires 60A, 60B positioned close to the opening of bottomed case 211. Lead wires 60A, 60B are led out from sealing member 212 and pass through base plate 213. Available examples of a material of bottomed case 211 include metal such as aluminum, stainless steel, copper, iron, or brass, and an alloy thereof.

Sealing member 212 is disposed at an opening of bottomed case 211 in which wound body 100 is housed, and an opening end of bottomed case 211 is crimped to sealing member 212 to form a curled part. Then, base plate 213 is disposed at curled part to seal wound body 100 in bottomed case 211. Sealing member 212 only needs to be an insulating substance, and is preferably an elastic body. As the elastic body, a material having excellent heat resistance such as silicone rubber or fluorocarbon rubber is preferable.

### EXAMPLES

Although the present disclosure will be described below in more detail based on Examples, the present disclosure is not limited to the Examples. Electrolytic capacitors of Examples and Comparative Examples were produced by the following procedure.

### (Preparation of Components)

Aluminum foil (with a thickness of 100 μm) was subjected to etching treatment to roughen a surface of the aluminum foil. The roughened surface of the aluminum foil was subjected to anodizing treatment to form a dielectric layer. In this way, anode foil provided on its surface with the dielectric layer was obtained.

Aluminum foil (with a thickness of 50 μm) was subjected to etching treatment to roughen a surface of the aluminum foil, thereby obtaining cathode foil.

A nonwoven fabric (with a thickness of 50 μm) was prepared as a separator. The nonwoven fabric is composed of 50 mass % (25 mass % of polyester fiber and 25 mass % of aramid fiber) of synthetic fibers and 50 mass % of cellulose, and contains polyacrylamide as a paper strength enhancer. A density of the nonwoven fabric was 0.35 g/cm³.

### (Preparation of First Processing Solution)

A first processing solution containing a first conductive polymer component, water, and a first polyhydric alcohol was prepared. A content of each component in the first processing solution was set to be a value shown in Table 1.

### (Preparation of 2A-th Processing Solution)

A 2A-th processing solution containing a 2A-th conductive polymer component, water, and a 2A-th polyhydric alcohol was prepared. A content of each component in the 2A-th processing solution was set to be a value shown in Table 2.

### (Preparation of 2B-th Processing Solution)

A 2B-th processing solution containing a 2B-th conductive polymer component, water, and a 2B-th polyhydric alcohol was prepared. A content of each component in the 2B-th processing solution was set to be a value shown in Table 3.

Poly (3,4-ethylenedioxythiophene) (PEDOT) (referred to below as “PEDOT/PSS”.) doped with polystyrene sulfonic acid (PSS) was used for each of the first conductive polymer component, the 2A-th conductive polymer component, and the 2B-th conductive polymer component.

Ethylene glycol was used for each of the first polyhydric alcohol, the 2A-th polyhydric alcohol, and the 2B-th polyhydric alcohol.

### (Formation of Conductive Polymer Layer)

The first processing solution was applied to both surfaces of the separator using a gravure coater, and a coating film was subjected to drying treatment to form a first conductive polymer layer. The drying treatment was performed by heating the separator coated with the first processing solution at 125° C. for 5 minutes. In this way, separator S with the first conductive polymer layer formed on the surface (to which the first conductive polymer component adhered) was produced. First processing solutions shown in Table 1 are used to produce S1 to S7 each as separator S.

TABLE 1

| | Composition of first processing solution | | | Mass change ratio R | Electrical |
|---|---|---|---|---|---|
| | First conductive | | First | of separator S before | conductivity of |
| | polymer | | polyhydric | and after immersion | first conductive |
| Separator S | component | Water | alcohol | into water | polymer layer |
| No. | (mass %) | (mass %) | (mass %) | (mass %) | (S/cm) |
| S1 | 2 | 98 | 0 | 49 | 0.024 |
| S2 | 2 | 96.8 | 1.2 | 44 | 0.026 |
| S3 | 2 | 95.6 | 2.4 | 40 | 0.030 |
| S4 | 2 | 93 | 5 | 33 | 0.022 |
| S5 | 2 | 88 | 10 | 11 | 8.300 |
| S6 | 2 | 83 | 15 | 9 | 35.990 |
| S7 | 2 | 78 | 20 | 17 | 108.793 |

The 2A-th processing solution was applied to both surfaces of the anode foil including the dielectric layer using the gravure coater, and a coating film was subjected to drying treatment to form a 2A-th conductive polymer layer. The drying treatment was performed by heating the anode foil coated with the 2A-th processing solution at 125° C. for 5 minutes. In this way, anode foil P with the 2A-th conductive polymer layer formed on each of the surfaces (to which the 2A-th conductive polymer component adhered) was produced. 2A-th processing solutions shown in Table 2 are used to produce P1 to P7 each as anode foil P.

TABLE 2

| | Composition of 2A-th processing solution | | | Mass change ratio R | Electrical |
|---|---|---|---|---|---|
| | 2A-th conductive | | 2A-th | of anode foil P | conductivity of |
| Anode | polymer | | polyhydric | before and after | 2A-th conductive |
| foil P | component | Water | alcohol | immersion into water | polymer layer |
| No. | (mass %) | (mass %) | (mass %) | (mass %) | (S/cm) |
| P1 | 2 | 98 | 0 | 2 | 0.014 |
| P2 | 2 | 96.8 | 1.2 | 3 | 0.028 |
| P3 | 2 | 95.6 | 2.4 | 2 | 0.023 |
| P4 | 2 | 93 | 5 | 2 | 0.051 |
| P5 | 2 | 88 | 10 | 1 | 0.934 |
| P6 | 2 | 83 | 15 | 1 | 40.477 |
| P7 | 2 | 78 | 20 | 1 | 62.377 |

With a similar method to that for the anode foil, a 2B-th conductive polymer layer was formed on both surfaces of the cathode foil using the 2B-th processing solution. In this way, cathode foil N with the 2B-th conductive polymer layer formed on each of the surfaces (to which the 2B-th conductive polymer component adhered) was produced. 2B-th processing solutions shown in Table 3 are used to produce N1 to N7 each as cathode foil N.

TABLE 3

| | Composition of 2B-th processing solution | | | Mass change ratio R | Electrical |
|---|---|---|---|---|---|
| | 2B-th conductive | | 2B-th | of cathode foil N | conductivity of |
| Cathode | polymer | | polyhydric | before and after | 2B-th conductive |
| foil N | component | Water | alcohol | immersion into water | polymer layer |
| No. | (mass %) | (mass %) | (mass %) | (mass %) | (S/cm) |
| N1 | 2 | 98 | 0 | 6 | 0.019 |
| N2 | 2 | 96.8 | 1.2 | 6 | 0.018 |
| N3 | 2 | 95.6 | 2.4 | 5 | 0.028 |
| N4 | 2 | 93 | 5 | 3 | 0.017 |
| N5 | 2 | 88 | 10 | 1 | 3.774 |
| N6 | 2 | 83 | 15 | 1 | 30.588 |
| N7 | 2 | 78 | 20 | 1 | 82.127 |

### (Production of Capacitor Element)

Anode foil P, cathode foil N, and separator S were each cut into a predetermined size. Anode foil P and cathode foil N were connected to an anode lead tab and a cathode lead tab, respectively. Next, anode foil P and cathode foil N were wound with separator S interposed between anode foil P and cathode foil N. The lead tabs protruding from the wound body are connected at ends to an anode lead wire and a cathode lead wire, respectively. The obtained wound body was subjected to the anodizing treatment again to form a dielectric layer on an end surface of the anode foil (aluminum foil). An end of an outer surface of the wound body was fixed with a winding stop tape. In this way, a capacitor element was obtained.

(Impregnation with Liquid Component)

Triethylamine phthalate was dissolved in ethylene glycol at a concentration of 25 mass % to prepare an electrolytic solution. The capacitor element was immersed in the electrolytic solution in a reduced-pressure atmosphere (40 kPa) for 5 minutes. In this way, the capacitor element (stacked body) was impregnated with the electrolytic solution.

### (Sealing of Capacitor Element)

The capacitor element impregnated with the electrolytic solution was sealed to produce an electrolytic capacitor as illustrated in FIG. 1. Then, aging was performed at 95° C. for 90 minutes while voltage was applied. In this way, the electrolytic capacitor was obtained.

Components (separator S, anode foil P, cathode foil N) shown in Tables 4 to 7 were used in the production of capacitor elements described above, thereby obtaining electrolytic capacitors. Here, A1 to A4 in Table 4, A11 to A12 in Table 5, and A21 to 22 in Table 6 are Examples, and B1 to B3 in Table 4, B11 to B14 in Table 5, B21 to B24 in Table 6, and B31 to B37 in Table 7 are Comparative Examples.

TABLE 4

| | Component | | | | |
|---|---|---|---|---|---|
| Electrolytic | | Anode | Cathode | ESR | ESR |
| capacitor | Separator | foil | foil | (100 kHz) | (120 Hz) |
| No. | S No. | P No. | N No. | (mΩ) | (Ω) |
| A1 | S1 | P7 | N7 | 16.27 | 0.392 |
| A2 | S2 | P7 | N7 | 16.62 | 0.589 |
| A3 | S3 | P7 | N7 | 16.30 | 0.347 |
| A4 | S4 | P7 | N7 | 16.45 | 0.307 |
| B1 | S5 | P7 | N7 | 20.49 | 1.152 |
| B2 | S6 | P7 | N7 | 22.78 | 0.847 |
| B3 | S7 | P7 | N7 | 20.03 | 0.927 |

TABLE 5

| | Component | | | | |
|---|---|---|---|---|---|
| Electrolytic | | Anode | Cathode | ESR | ESR |
| capacitor | Separator | foil | foil | (100 kHz) | (120 Hz) |
| No. | S No. | P No. | N No. | (mΩ) | (Ω) |
| B11 | S1 | P1 | N7 | 19.87 | 0.895 |
| B12 | S1 | P2 | N7 | 19.25 | 1.384 |
| B13 | S1 | P3 | N7 | 18.98 | 1.563 |
| B14 | S1 | P4 | N7 | 17.89 | 0.727 |
| A11 | S1 | P5 | N7 | 16.86 | 0.587 |
| A12 | S1 | P6 | N7 | 16.59 | 0.546 |
| A1 | S1 | P7 | N7 | 16.27 | 0.392 |

TABLE 6

| | Component | | | | |
|---|---|---|---|---|---|
| Electrolytic | | Anode | Cathode | ESR | ESR |
| capacitor | Separator | foil | foil | (100 kHz) | (120 Hz) |
| No. | S No. | P No. | N No. | (mΩ) | (Ω) |
| B21 | S1 | P7 | N1 | 21.05 | 0.879 |
| B22 | S1 | P7 | N2 | 20.17 | 1.032 |
| B23 | S1 | P7 | N3 | 20.00 | 1.177 |
| B24 | S1 | P7 | N4 | 19.15 | 0.690 |
| A21 | S1 | P7 | N5 | 16.72 | 0.353 |
| A22 | S1 | P7 | N6 | 17.23 | 0.488 |
| A1 | S1 | P7 | N7 | 16.27 | 0.392 |

TABLE 7

| | Component | | | | |
|---|---|---|---|---|---|
| Electrolytic | | Anode | Cathode | ESR | ESR |
| capacitor | Separator | foil | foil | (100 kHz) | (120 Hz) |
| No. | S No. | P No. | N No. | (mΩ) | (Ω) |
| B31 | S1 | P1 | N1 | 21.14 | 2.988 |
| B32 | S2 | P1 | N1 | 18.51 | 1.429 |
| B33 | S3 | P1 | N1 | 19.66 | 1.552 |
| B34 | S4 | P1 | N1 | 20.70 | 1.096 |
| B35 | S5 | P1 | N1 | 21.45 | 0.993 |
| B36 | S6 | P1 | N1 | 18.80 | 1.049 |
| B37 | S7 | P1 | N1 | 19.36 | 1.130 |

### [Evaluation of Each Component]

(Mass Change Ratio of Each Component Before and After Immersion into Water)

Mass change ratio R before and after immersion into water was determined for each of components of anode foil P, cathode foil N, and separator S by the method described above. Determined mass change ratios R are shown in Tables 1 to 3.

Mass change ratio R in each of S1 to S4 produced using the first processing solution having a content of less than 10 mass % (5 mass % or less) of the first polyhydric alcohol was 20 mass % or more. That is, mass change ratio R in each of S1 to S4 was larger than that in each of S5 to S7 produced using the first processing solution having a content of 10 mass % or more of the first polyhydric alcohol. These results show that the first conductive polymer component in each of S1 to S4 was likely to be migrated to the 2A-th conductive polymer component or the 2B-th conductive polymer component when the capacitor element was impregnated with the liquid component.

Mass change ratio R in each of P5 to P7 produced using the 2A-th processing solution having a content of 10 mass % or more of the 2A-th polyhydric alcohol was less than 2 mass %. That is, mass change ratio R in each of P5 to P7 is smaller than that in each of P1 to P4 produced using the 2A-th processing solution having a content of less than 10 mass % of the 2A-th polyhydric alcohol. These results show that the 2A-th conductive polymer component in each of P5 to P7 had high adhesion.

Mass change ratio R in each of N5 to N7 produced using the 2B-th processing solution having a content of 10 mass % or more of the 2B-th polyhydric alcohol was less than 2 mass %. That is, mass change ratio R in each of N5 to N7 was smaller than that in each of N1 to N4 produced using the 2B-th processing solution having a content of less than 10 mass % of the 2B-th polyhydric alcohol. These results show that the 2B-th conductive polymer component in each of N5 to N7 had high adhesion.

In each of S1 to S4, a mass of the first polyhydric alcohol in the first processing solution was less than 5 times a mass of the first conductive polymer component. In each of P5 to P7, a mass of the 2A-th polyhydric alcohol in the 2A-th processing solution was 5 times or more a mass of the 2A-th conductive polymer component. In each of N5 to N7, a mass of the 2B-th polyhydric alcohol in the 2B-th processing solution was 5 times or more a mass of the 2B-th conductive polymer component.

### (Electrical Conductivity of Conductive Polymer Layer Formed on Surface of Each Component)

Then, an electrical conductivity of the conductive polymer layer formed on the surface of each component was determined by the method described above. Determined electrical conductivities are shown in Tables 1 to 3.

In each of S1 to S4 produced using the first processing solution having a content of less than 10 mass % (5 mass % or less) of the first polyhydric alcohol, the first conductive polymer layer formed on the surface of the separator had an electrical conductivity of 0.1 S/cm or less, which was lower than that in each of S5 to S7 produced using the first processing solution having a content of 10 mass % or more of the first polyhydric alcohol.

In each of P5 to P7 produced using the 2A-th processing solution having a content of 10 mass % or more of the 2A-th polyhydric alcohol, the 2A-th conductive polymer layer formed on the surface of the anode foil had an electrical conductivity of 0.5 S/cm or more, which was higher than that in each of P1 to P4 produced using the 2A-th processing solution having a content of less than 10 mass % of the 2A-th polyhydric alcohol.

In each of N5 to N7 produced using the 2B-th processing solution having a content of 10 mass % or more of the 2B-th polyhydric alcohol, the 2B-th conductive polymer layer formed on the surface of the cathode foil had an electrical conductivity of 0.5 S/cm or more, which was higher than that in each of N1 to N4 produced using the 2B-th processing solution having a content of less than 10 mass % of the 2B-th polyhydric alcohol.

### [Evaluation of Electrolytic Capacitor: Measurement of ESR]

ESR (mΩ) of the electrolytic capacitor at each of frequencies of 100 kHz and 120 Hz was measured in an environment of 20° C. using an LCR meter for 4-terminal measurement. Measurement results are shown in Tables 4 to 7.

ESR was obtained in both a high frequency region and a low frequency region in each of A1 to A4, A11 to A12, and A21 to 22, the ESR being lower than that in each of B1 to B3, B11 to B13, B21 to B23, and B31 to B37. Each of A1 to A4, A11 to A12, and A21 to 22 used separator S produced using the first processing solution having a content of less than 10 mass % of the first polyhydric alcohol, and anode foil P and cathode foil N each produced using the second processing solution having a content of 10 mass % or more of the second polyhydric alcohol.

In each of A1 to A4, A11 to A12, and A21 to 22, a mass of the liquid component was 20 times or more a total mass of the first conductive polymer component, the 2A-th conductive polymer component, and the 2B-th conductive polymer component.

### <<Supplementary Note>>

Techniques below are disclosed by the description of the above exemplary embodiments.

### (Technique 1)

A method for manufacturing an electrolytic capacitor, the method including the steps of:
preparing an anode foil, a cathode foil, and a separator, the anode foil including a dielectric layer,
preparing a first processing solution containing a first conductive polymer component;
preparing a second processing solution containing a second conductive polymer component;
adhering the first conductive polymer component to the separator by applying the first processing solution to the separator;
adhering the second conductive polymer component to at least one of the anode foil or the cathode foil by applying the second processing solution to the at least one of the anode foil or the cathode;
producing a capacitor element by sequentially stacking the anode foil, the separator to which the first conductive polymer component adheres, and the cathode foil after the step of adhering the second conductive polymer component; and
impregnating the capacitor element with a liquid component, wherein:
the first processing solution contains a first polyhydric alcohol or does not substantially contain the first polyhydric alcohol,
a content of the first polyhydric alcohol in the first processing solution is 0 mass % or more and less than 10 mass %,
the second processing solution contains a second polyhydric alcohol, and
a content of the second polyhydric alcohol in the second processing solution is 10 mass % or more.

### (Technique 2)

The method described in Technique 1, in which the step of impregnating the liquid component includes a step of migrating the first conductive polymer component into the second conductive polymer component to increase a conductive path between the second conductive polymer component and the first conductive polymer component.

### (Technique 3)

The method described in Technique 1 or 2, in which the first polyhydric alcohol and the second polyhydric alcohol each contain at least one selected from the group consisting of a glycol compound, a glycerin compound, and a sugar alcohol compound.

### (Technique 4)

The method described in any one of Techniques 1 to 3, in which the liquid component contains a third polyhydric alcohol.

### (Technique 5)

The method described in Technique 4, in which the third polyhydric alcohol contains at least one selected from the group consisting of a glycol compound, a glycerin compound, and a sugar alcohol compound.

### (Technique 6)

The method described in any one of Techniques 1 to 5, in which the liquid component contains an amine salt of an organic acid.

### (Technique 7)

The method described in any one of Techniques 1 to 6, in which in the first processing solution, a mass of the first polyhydric alcohol is a mass less than 5 times a mass of the first conductive polymer component.

### (Technique 8)

The method described in any one of Techniques 1 to 7, in which in the second processing solution, a mass of the second polyhydric alcohol is from 5 times to 25 times, inclusive, a mass of the second conductive polymer component.

### (Technique 9)

An electrolytic capacitor including:
a capacitor element; and
a liquid component,
the capacitor element including:
an anode foil including a dielectric layer;
a cathode foil;
a separator disposed between the anode foil and the cathode foil;
a first conductive polymer component adhering to the separator; and
a second conductive polymer component adhering to at least one of the anode foil or the cathode foil,
the first conductive polymer component having a higher solubility in water than a solubility of the second conductive polymer component, in water

### (Technique 10)

The electrolytic capacitor described in Technique 9, in which
in a condition that an immersion of the separator to which the first conductive polymer component adheres in water at 25° C. for 10 minutes is conducted, the separator being preliminarily dried at 105° C. for 30 minutes, and then the separator is dried again at 105° C. for 30 minutes, a mass change ratio R of the separator before and after the immersion is 20 mass % or more, and
in a condition that an immersion of at least one of the anode foil or the cathode foil to which the second conductive polymer component adheres in water at 25° C. for 10 minutes, the at least one of the anode foil or the cathode foil being preliminarily dried at 105° C. for 30 minutes, and then the at least one of the anode foil or the cathode foil is dried again at 105° C. for 30 minutes, a mass change ratio R of the at least one of the anode foil or the cathode foil before and after the immersion is less than 2 mass %.

### (Technique 11)

The electrolytic capacitor described in Technique 9 or 10, in which
an electrical conductivity of the first conductive polymer component is 0.1 S/cm or less, and
an electrical conductivity of the second conductive polymer component is 0.5 S/cm or more.

### (Technique 12)

The electrolytic capacitor described in Technique 9, in which a mass of the liquid component is 20 times or more a total mass of the first conductive polymer component and the second conductive polymer component.

### (Technique 13)

A first processing solution applied to a separator constituting a capacitor element of an electrolytic capacitor including the capacitor element and a liquid component, wherein:
the first processing solution contains a first conductive polymer component,
the first processing solution further contains a first polyhydric alcohol or does not substantially contain the first polyhydric alcohol,
a content of the first polyhydric alcohol in the first processing solution is 0 mass % or more and less than 10 mass %, and
the first conductive polymer component adhering to the separator by applying the first processing solution to the separator migrates to another adjacent conductive polymer component in impregnating the liquid component into the capacitor element.

### (Technique 14)

A second processing solution applied to at least one of anode foil and cathode foil constituting a capacitor element of an electrolytic capacitor including the capacitor element and a liquid component, the second processing solution being used together with the first processing solution described in Technique 13, wherein:
the second processing solution contains a second conductive polymer component and a second polyhydric alcohol, and
a content of the second polyhydric alcohol in the second processing solution is 10 mass % or more.

### INDUSTRIAL APPLICABILITY

The method for manufacturing an electrolytic capacitor according to the present disclosure is suitably used for an electrolytic capacitor requiring low ESR.

### REFERENCE MARKS IN THE DRAWINGS

10 anode foil
20 cathode foil
30 separator
40 winding stop tape
50A, 50B lead tab
60A, 60B lead wire
100 wound body
200 electrolytic capacitor
211 bottomed case
212 sealing member
213 base plate

1. A method for manufacturing an electrolytic capacitor, the method comprising the steps of:
preparing an anode foil, a cathode foil, and a separator, the anode foil including a dielectric layer;
preparing a first processing solution containing a first conductive polymer component;
preparing a second processing solution containing a second conductive polymer component;
adhering the first conductive polymer component to the separator by applying the first processing solution to the separator;
adhering the second conductive polymer component to at least one of the anode foil or the cathode foil by applying the second processing solution to the at least one of the anode foil or the cathode foil;
producing a capacitor element by sequentially stacking the anode foil, the separator to which the first conductive polymer component adheres, and the cathode foil after the step of adhering the second conductive polymer component; and
impregnating the capacitor element with a liquid component, wherein:
the first processing solution contains a first polyhydric alcohol or does not substantially contain the first polyhydric alcohol,
a content of the first polyhydric alcohol in the first processing solution is 0 mass % or more and less than 10 mass %,
the second processing solution contains a second polyhydric alcohol, and
a content of the second polyhydric alcohol in the second processing solution is 10 mass % or more.

2. The method according to claim 1, wherein the step of impregnating the capacitor element with the liquid component includes a step of migrating the first conductive polymer component into the second conductive polymer component to increase a conductive path between the second conductive polymer component and the first conductive polymer component.

3. The method according to claim 1, wherein the first polyhydric alcohol and the second polyhydric alcohol each contain at least one selected from the group consisting of a glycol compound, a glycerin compound, and a sugar alcohol compound.

4. The method according to claim 1, wherein the liquid component contains a third polyhydric alcohol.

5. The method according to claim 4, wherein the third polyhydric alcohol contains at least one selected from the group consisting of a glycol compound, a glycerin compound, and a sugar alcohol compound.

6. The method according to claim 4, wherein the liquid component contains an amine salt of an organic acid.

7. The method according to claim 1, wherein in the first processing solution, a mass of the first polyhydric alcohol is less than 5 times a mass of the first conductive polymer component.

8. The method according to claim 1, wherein in the second processing solution, a mass of the second polyhydric alcohol is from 5 times to 25 times, inclusive, a mass of the second conductive polymer component.

9. An electrolytic capacitor comprising:
a capacitor element; and
a liquid component, wherein:
the capacitor element includes:
an anode foil including a dielectric layer;
a cathode foil;
a separator disposed between the anode foil and the cathode foil;
a first conductive polymer component adhering to the separator; and
a second conductive polymer component adhering to at least one of the anode foil or the cathode foil, and
the first conductive polymer component has a higher solubility in water than a solubility of the second conductive polymer component in water.

10. The electrolytic capacitor according to claim 9, wherein:
in a condition that an immersion of the separator to which the first conductive polymer component adheres in water at 25° C. for 10 minutes is conducted, the separator being preliminarily dried at 105° C. for 30 minutes, and then the separator is dried again at 105° C. for 30 minutes, a mass change ratio R of the separator after the immersion to the separator before the immersion is 20 mass % or more, and
in a condition that an immersion of at least one of the anode foil or the cathode foil to which the second conductive polymer component adheres in water at 25° C. for 10 minutes, the at least one of the anode foil or the cathode foil being preliminarily dried at 105° C. for 30 minutes, and then the at least one of the anode foil or the cathode foil is dried again at 105° C. for 30 minutes, a mass change ratio R of the at least one of the anode foil or the cathode foil after the immersion to the at least one of the anode foil or the cathode foil before the immersion is less than 2 mass %.

11. The electrolytic capacitor according to claim 9, wherein:
an electrical conductivity of the first conductive polymer component is 0.1 S/cm or less, and
an electrical conductivity of the second conductive polymer component is 0.5 S/cm or more.

12. The electrolytic capacitor according to claim 9, wherein a mass of the liquid component is 20 times or more a total mass of the first conductive polymer component and the second conductive polymer component.

13. A first processing solution for producing an electrolytic capacitor including a capacitor element and a liquid component, the first processing solution being to be applied to a separator constituting the capacitor element, wherein:
the first processing solution contains a first conductive polymer component,
the first processing solution further contains a first polyhydric alcohol or does not substantially contain the first polyhydric alcohol,
a content of the first polyhydric alcohol in the first processing solution is 0 mass % or more and less than 10 mass %, and
the first conductive polymer component adhering to the separator by applying the first processing solution to the separator migrates to another adjacent conductive polymer component in impregnating the liquid component into the capacitor element.

14. A second processing solution for producing an electrolytic capacitor including a capacitor element and a liquid component, the second processing solution being to be applied to at least one of an anode foil and a cathode foil constituting the capacitor element, the second processing solution being used together with the first processing solution according to claim 13, wherein:
the second processing solution contains a second conductive polymer component and a second polyhydric alcohol, and
a content of the second polyhydric alcohol in the second processing solution is 10 mass % or more.
